(19) United States
(12) Patent Application Publication
(10) Pub. No.: US 2023/0220261 A1
(43) Pub. Date: Jul. 13, 2023

(54) POLYMERIC COMPOSITION CONTAINING A PHASE CHANGE MATERIAL

(71) Applicants: SABANCI UNIVERSITESI, Istanbul (TR); SABANCI UNIVERSITESI NANOTEKNOLOJI ARASTIRMA VE UYGULAMA MERKEZI SUNUM, Istanbul (TR)

(72) Inventors: Hayriye UNAL, Istanbul (TR); Cuneyt Erdinc TAS, Istanbul (TR)

(73) Assignees: SABANCI UNIVERSITESI, Istanbul (TR); SABANCI UNIVERSITESI NANOTEKNOLOJI ARASTIRMA VE UYGULAMA MERKEZI SUNUM, Istanbul (TR)

(21) Appl. No.: 17/914,384

(22) PCT Filed: Mar. 25, 2021
(86) PCT No.: PCT/TR2021/050268

§ 371 Date: Sep. 26, 2022

(30) Foreign Application Priority Data
Mar. 26, 2020 (TR) 2020/04773

(51) Int. Cl. C09K 5/06; C08K 9/04; C08J 5/18; C08J 7/06; C09C 3/08; C09C 3/10; C09C 1/42; B65D 81/18

(52) U.S. Cl. CPC C09K 5/066; C08K 9/04; C08J 5/18; C08J 7/065; C09C 3/08; C09C 3/10; C09C 1/42; B65D 81/18; C08K 2201/011; C08K 2201/001; C08J 2323/06; C08J 2323/12; C08J 2325/06; C08J 2327/06; C08J 2367/02; C08J 2369/00; C08J 2377/00; C01P 2004/13; C01P 2006/32

(57) ABSTRACT

A polymeric composition containing at least one polymer and halloysite nanotubes is disclosed. At least a portion of the halloysite nanotubes is loaded with a phase change material and each of the loaded halloysite nanotubes contains at most one kind of phase change material. In addition, a preparation method and use of the polymeric composition are further provided.

### CROSS REFERENCE TO THE RELATED APPLICATIONS

This application is the national phase entry of International Application No. PCT/TR2021/050268, filed on Mar. 25, 2021, which is based upon and claims priority to Turkish Patent Application No. 2020/04773, filed on Mar. 26, 2020, the entire contents of which are incorporated herein by reference.

### TECHNICAL FIELD

The present invention relates to a polymeric composition containing a phase change material and a method for producing the polymeric composition. More particularly, the present invention relates to a polymeric composition in the form of a film suitable for use in the cold chain, and a method for producing thereof.

### BACKGROUND

Thermal energy storage systems containing phase change materials are of great interest today. Said phase change materials absorb or release heat from or into the environment during the solid-liquid transformations. During the phase change, even if there is a change in temperature of the material in question, the temperature change is negligible. Almost no temperature change is observed when the heat energy is stored in this way, it is thus called latent heat storage. Upon an increase in the ambient temperature and once the temperature of the composition containing a phase change material reaches the melting temperature of the phase change material, the phase change material in solid state absorbs heat from the environment and changes its phase into a liquid state. Said phase change material continues to absorb heat from the environment until it is completely liquid, thereby cooling its environment. Ice, which cools its environment in accordance with the phase change principle, is one of the most widely used phase change materials.

On the contrary, as a result of a decrease in the ambient temperature and once the temperature of the composition containing a phase change material reaches the freezing point of the phase change material, the phase change material in liquid state begins to solidify, and in the meantime, heat is released to the environment. In this way, the phase change material is enabled to heat its environment.

Thermal energy storage systems based on the use of latent heat for heating or cooling purposes present a much more effective and advantageous method compared to the apparent heat storage method.

Phase change materials are used in many areas where heating and cooling processes are required. It is preferable in the transportation and storage of hot food products, in the logistics of products such as food and medicine that need to be transported in the cold chain, in preventing electronic devices from heating, in textile products designed for protection from cold or heat, in healthcare applications such as transportation of blood samples and organs, in heating and cooling of the buildings, and in hot and cold applications in the health sector.

With the systems containing phase change materials that are used especially to keep materials that need to be kept cold at a certain temperature range for a certain period of time, less energy is required.

In the prior art, there are some systems that involve the use of phase change materials, to be used in products that need to be kept at a certain temperature range during transportation and that are subjected to the cold chain application, such as food, medicine, and blood samples. In cold chain applications, it is intended to keep the products to be stored at a temperature range of 2° C.-8° C. for a certain period of time. These vital products such as food, medical products, blood, and organs can be kept for a certain period of time such that the temperature remains at the desired level without deteriorating its structure. The duration may vary depending on the thermal insulation material used and on the system. Keeping the temperature at the targeted range, especially during the transportation of such products from one location to another, is a very important requirement to protect the products from spoiling.

Huang et al. (https://doi.org/10.3390/app7121288) describes a system in which a phase change material is used, where the temperature can be kept in the range of 2° C.-8° C. Here, an interior surface of a container is lined with two different panels containing a phase change material. In said study, water and a mixture of water and alkane is mentioned as a suitable phase change material.

Melone et al. (https://doi.org/10.1016/j.apenergy.2011.07.039) studies the application of a phase change material to paper material.

Xiaofeng et al. (https://doi.org/10.1002/er.4187) examines the use of a phase change material in the cold chain system, in order to keep the temperature between −5° C. and 8° C. In order to cover an insulation box, water, polyacrylic acid sodium and multi-walled carbon nanotubes are incorporated into the system.

Lagaron et al. (https://doi.org/10.1016/j.jfoodeng.2015.01.019) discloses coating of a surface of polystyrene foam trays with a fibrous polystyrene/phase change material in a thermal system that is defined in order to keep the food products in the cold chain at a temperature range of 2° C.-8° C. It is stated that the resulting polystyrene foam trays are used as food packaging material.

Thermal insulation materials having thereon a phase change material and/or thermal insulation systems made of insulation materials such as cardboard and foam, can keep the products in the cold chain application within the targeted temperature range for a certain period of time. Thermal insulation of the packaging materials such as cardboard boxes and foam is limited, which may be insufficient for long term requirements. In such cases, although systems containing a phase change material are used, in the event that the atmospheric temperature rises suddenly or it is waited longer than anticipated, the existing thermal insulation system may not be able to keep the stored product cold any longer as it cannot provide additional protection. Because when the phase change material is completely converted from the solid state into the liquid state, the cooling effect of the system containing the phase change material disappears. This means breakage of the cold chain, and a temperature rise in the stored products may result in the spoilage of the products in question. In order to ensure that the materials carried by the cold chain system are not spoiled, the temperature is expected to be kept at a certain range for the targeted period, which is desired to be as long as possible.

It has been determined that there is a need for systems to ensure that products being transported or stored in the cold chain remain at the desired temperature range for the targeted period, without being affected by sudden temperature changes.

On the other hand, it may always not be possible to provide an insulation material that can match the size and shape of the products to be stored. For example, using large insulation materials to store and transport small products can cause difficulties in the logistics process. In such a case, each product should be kept with different insulation materials since it is not desired to open and close the insulation material during the storage and transportation period in order not to break the cold chain. In this case, it is preferred that the material for thermal insulation is of similar dimensions with the product that is desired to be kept cold. Otherwise, it will occupy more space than necessary compared to the volume of the products to be stored. In addition, insulation materials such as boxes occupy a large area before use, which can be a problem in some cases. It is desirable that the material for thermal insulation adapts to the shape of the product to be stored, regardless of whether it is small or large.

In order to overcome the above-mentioned difficulties, there is a need for thermal insulation systems that will ensure that the products that need to be kept cold remain at the desired temperature range for a certain period of time without being affected by the ambient temperature, and provide protection against sudden temperature increases, also offering a practical use.

The main object of the present invention is to obtain a thermal insulation material that can keep the cold chain products at the target temperature range for a certain period of time without causing deterioration in the nature of said product.

Another object of the present invention is to maintain the products transported in the cold chain at the target temperature range for a longer period of time.

Another object of the present invention is to obtain a thermal insulation material that offers a practical application and does not take up much space.

Another object of the present invention is to obtain a low-cost thermal insulation material that can be produced in an easy manner.

Still another object of the present invention is to obtain a thermal insulation material that is resistant to environmental factors and external effects.

### SUMMARY

The present invention describes a polymeric composition containing at least one polymer and halloysite nanotubes, wherein at least a portion of the halloysite nanotubes is loaded with a phase change material and each of the loaded halloysite nanotubes contains at most one kind of phase change material.

### BRIEF DESCRIPTION OF THE DRAWINGS

The drawings, whose brief description is provided below, are solely intended for providing a better understanding of the present invention and are as such not intended to define the scope of protection or the context in which said scope is to be interpreted in the absence of the description.

FIG. 1 shows the loading of halloysite nanotubes with a phase change material according to the present invention. “HNT” halloysite nanotubes, FMD1, FMD2, FMD3 define different phase change materials.

FIG. 2 shows halloysite nanotubes loaded with the phase change material according to the present invention and FIG. 1.

### DETAILED DESCRIPTION OF THE EMBODIMENTS

The present invention provides a polymeric composition containing at least one polymer and halloysite nanotubes. At least a portion of the halloysite nanotubes in the polymeric composition of the present invention is loaded with a phase change material and each of the loaded halloysite nanotubes contains at most one kind of phase change material.

Halloysite is a crystalline clay mineral belonging to the kaolin group, which is in the form of nanotubes in nature, with the chemical formula Al₂[Si₂O₅(OH)₄]·2H₂O, consisting of two-layered layers with silica on the outer surface and alumina layer on the inner surface. The sizes and shapes of halloysite clay mineral may vary depending on the deposits where it is found and on the conditions of formation, and it can be found in a variety of morphologies such as tubular, spherical, or rod-like, which is mostly in broad, tubular form. It has been observed that the polymeric composition incorporating halloysite nanotubes acquires barrier properties. Halloysite nanotubes, a type of nanoparticle, form a meandering structure in the composition. Thus, various gases in the external environment are prevented from moving through said polymeric composition.

According to the invention, at least a portion of the halloysite nanotubes in the polymeric composition is loaded with a phase change material. The halloysite nanotubes used herein are natural materials that do not have toxic effects. Halloysite could be loaded with the phase change material by virtue of the nano-sized lumens contained therein. It is not necessary for all halloysite nanotubes in the polymeric composition to be loaded with the phase change material. It is sufficient to load at least a portion of said halloysites with the phase change material.

Most of the phase change materials used for cooling purposes are in liquid state at room temperature. Therefore, it is difficult to incorporate the phase change materials in any system, which may also cause problems during use such as leakage. In this case, the phase change materials are encapsulated and loaded into halloysite nanotubes.

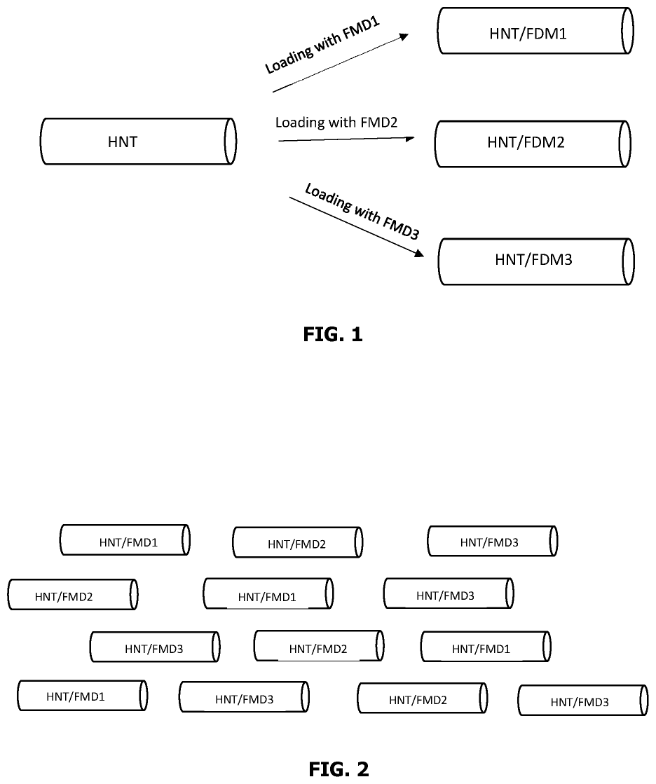

What matters here is that each of the loaded halloysite nanotubes contains at most one kind of phase change material. Referring to FIG. 1, each of the loaded halloysite nanotubes can contain at most one kind of phase change material. With the polymeric composition having such a structure, products that are desired to be kept cold at a certain temperature range can be kept intact for the desired period of time. Especially, when the cold chain products experience an unexpected increase in temperature, the thermal insulation material applied to said product loses its effect quickly and may be insufficient to perform the cold-keeping function. Therefore, if sunlight is suddenly incident on the product whose temperature is desired to be preserved, or it contacts with the ambient air for a longer period of time than anticipated, it is expected that the thermal insulation material applied to such product exerts its effect for a shorter period of time than intended. At this point, it is found that the polymeric compositions containing at least one polymer and halloysite nanotubes, wherein at least a portion of said halloysite nanotubes is loaded with a phase change material, and each of the loaded halloysite nanotubes contains at most one kind of phase change material, allow cold chain products to be kept at the desired temperature range for a longer period of time.

During their trials, the inventors observed that the thermal insulation performance of the resulting polymeric composition is increased when each of the loaded halloysites is loaded with at most one phase change material.

In another embodiment of the present invention, all of said loaded halloysite nanotubes may contain a single type of phase change material. Thus, since all of the phase change material in the polymeric composition will be converted from the solid state to the liquid state at the same temperature, said phase change material will absorb heat during melting. Thus, the polymeric composition containing the phase change material is enabled to exert a cold-keeping effect.

In another embodiment of the present invention, said loaded halloysite nanotubes may contain at least two different phase change materials. Since the melting temperatures of different phase change materials will be different from each other, a possible solid-liquid phase change is observed in a wider temperature range. As shown in FIG. 1 and FIG. 2, if the loaded halloysite nanotubes contain at most one phase change material and said phase change material is available in two in number, one different from the other, a phase change occurs at at least two different temperatures. In this way, its thermal insulation efficiency is increased.

In another embodiment, each of the loaded halloysites in the polymeric composition may contain an equal amount of the phase change material. In this way, by adjusting the amount of the phase change material in said polymeric composition in a controlled manner, the thermal insulation capacity is increased.

According to another embodiment of the present invention, the polymeric composition may contain 1%-40% by weight of halloysite nanotubes, preferably 5%-20% by weight. By using said amount of halloysite nanotubes, the cooling effect of the polymeric composition is increased.

In another embodiment of the invention, the polymer used in the polymeric composition is a thermoplastic polymer. By using a thermoplastic polymer, the strength of the resulting polymeric composition is increased. According to another embodiment of the invention, the thermoplastic polymer used in the polymeric composition may include polyethylene, polypropylene, polyethylene terephthalate, polyamide, polystyrene, polyvinylchloride, polycarbonate, or a combination thereof. It is determined that the polymeric composition containing said thermoplastic polymers is more resistant to external factors such as temperature and pressure. The most preferred thermoplastic polymer is polyethylene.

According to another embodiment of the invention, the melting temperature of the phase change material in the polymeric composition can range from −20° C. to 20° C. It is very critical to choose the appropriate phase change material in the thermal insulation system. When the temperature of the polymeric composition containing the phase change material reaches the melting temperature of the phase change material, the transition from the solid state to the liquid state, i.e., melting begins. The phase change materials with the appropriate melting temperature value increase the effectiveness of the thermal insulation system in which they are contained. By using the phase change materials with a melting temperature of −20° C. to 20° C., a polymeric composition may be obtained which acts as a buffer against temperature increases in the range of −20° C. to 20° C., i.e., has the ability to keep its temperature below the ambient temperature.

Systems containing phase change materials that are used to provide thermal insulation for cold chain products such as food or medicaments should be non-toxic and non-corrosive, non-flammable and non-explosive. In addition, the phase change material is expected to be chemically stable during the use of the thermal insulation system. The phase change material to be used in the polymeric composition of the present invention must satisfy all of these properties.

The amount of heat required to complete a phase change between solid-liquid states is defined as latent heat. Meanwhile, the amount of heat absorbed from or released into the outside determines the performance of the insulation system containing said phase change material. Materials that need more heat during the solid-liquid phase transition will cool their environment more effectively. One of the problems with the thermal storage systems is that the amount of heat absorbed by or released from said materials during the phase change is limited.

According to another embodiment of the invention, organic materials can be used as phase change materials. It has been observed that organic phase change materials can absorb a greater amount of heat during phase change, thereby capable of cooling its environment more effectively.

Particularly, it has been observed that fatty acid, polymeric material, paraffin-based material, and a combination thereof exhibit superior thermal properties. The thermal property of a phase change material is very critical in terms of its contribution to the thermal insulation material containing it. In other words, the thermal property of a material defines the characteristics of the polymeric composition used as a thermal insulation system.

In another embodiment of the invention, in the polymeric composition of the present invention, triethylene glycol, polyethylene glycol 400, polyethylene glycol 600, or a combination thereof can be used as phase change material. It has been observed that by using said phase change materials or a combination thereof, the latent heat that can be stored per unit volume increases. In this way, it has been found that said products can be kept at the desired temperature range for a longer period of time, thanks to the thermal insulation systems used in the storage of cold chain products, which contain one or a combination of said phase change materials. Also, with said phase change materials, it is concluded that the volume change after the phase change is minimized.

In another embodiment of the present invention, in addition to halloysite nanotubes loaded with the phase change material, hollow halloysite nanotubes may also be present in the polymeric composition of the present invention. In such an arrangement, it has been found that in addition to the cooling effect of the polymeric composition according to the invention, the addition of hollow halloysite nanotubes prevents the gas in the environment from penetrating into said polymeric composition. The hollow halloysite nanotubes are dispersed in the polymeric composition, forming a meandering path. In this way, with the polymeric composition of the invention, it has been found that gases such as oxygen, carbon dioxide, and ethylene in the environment, and the humidity and odor therein can be trapped.

According to another embodiment of the invention, the polymeric composition can be in the form of a film. Melone et al. (doi:10.1016/j.apenergy.2011.07.039) describes that systems obtained by integrating phase change materials into paper-based products are used to preserve foods that need to be kept cold. The inventors found that there is a need for a product that provides ease of use. Even if there is a thermal insulation system applied to the cold chain products, a system is desirable which is suitable for use with said system, and in which the cooling effect is increased, in case of an unexpected increase in the temperature or unforeseen long waiting times. It has been found that if no heat insulation system is used, a structure is required that will help to keep said products at a certain temperature range for a certain period of time. At this point, the inventors proposes that the polymeric composition containing at least one polymer and halloysite nanotubes, wherein at least a portion of said halloysite nanotubes is loaded with a phase change material and each of the loaded halloysite nanotubes contains at most one kind of phase change material, can be in the form of a film. The polymeric film structure is very practical in use, and since it can be applied to any product regardless of the shape and size of the product to be stored, it finds a wide range of use. The aim is to cover all surfaces of the product to be stored with the inventive polymeric composition in the form of a film. In this way, by preventing a contact of the product with air, heat insulation is provided.

According to another embodiment of the invention, the composition in the form of a polymeric film may have a flexible structure.

With its flexible structure, it can be easily applied to all kinds of products. Also, cold chain products that have an indented surface rather than a flat one may not be completely covered by inelastic polymeric films. A smallest part of the surface that cannot be covered will cause breakage of the cold chain. With the flexible structure, it is found that all kinds of products can be coated practically.

According to another embodiment of the invention, the film thickness of said polymeric film may be in the range of 10 μm-70 μm. It is determined that polymeric films with a film thickness in the range of 10 μm-70 μm have a more flexible structure. With the flexible structure, the products can be coated without leaving any space on their surfaces, which provides an effective thermal insulation.

In another embodiment of the invention, halloysite nanotubes loaded with the phase change material may be dispersed in said polymeric film and/or coated on the surface of the polymeric film. It is determined that it exhibits a good dispersion depending on the surface properties, where the halloysite nanotubes are dispersed in the polymeric film. In this case, the phase change materials are homogeneously distributed in the film and the desired thermal insulation is provided more effectively.

According to the invention, a method of producing a polymeric composition containing at least one polymer and halloysite nanotubes comprises the steps of:
loading at least a portion of the halloysite nanotubes with a phase change material, wherein each of the loaded halloysite nanotubes contains at most one type of phase change material,
mixing the halloysite nanotubes loaded with the phase change material with at least one polymer in order to obtain a polymeric composition.

In the production method mentioned herein, all of the loaded halloysite nanotubes may contain one type of phase change material.

According to another embodiment, the loaded halloysite nanotubes in said production method may contain at least two different phase change materials.

In order to obtain the polymeric composition of the present invention, said method may comprise the steps of:
dissolving the phase change material in a solvent and subjecting it sonication together with the halloysite nanotubes,
impregnating the phase change material into the halloysite nanotubes by removing the solvent in the medium by vacuuming.

According to the invention, the polymer used in said production method may be a type of thermoplastic polymer. Said thermoplastic polymer may include polyethylene, polypropylene, polyethylene terephthalate, polyamide, polystyrene, polyvinylchloride, polycarbonate, or a combination thereof. Particularly preferred thermoplastic polymer is polyethylene.

According to the invention, the melting temperature of the phase change material used in the production method may range from −20° C. to 20° C.

According to another embodiment, in said production method, halloysite nanotubes may be loaded with organic phase change materials. Said phase change material may contain fatty acid, polymeric material, paraffin-based material, or a combination thereof. In an embodiment of the invention, triethylene glycol, polyethylene glycol 400, polyethylene glycol 600, or a combination thereof may be used as phase change material.

According to another embodiment of the invention, in the production method of said polymeric composition, in addition to the halloysite nanotubes loaded with the phase change material, hollow halloysite nanotubes can also be added.

According to another embodiment of the invention, the polymeric composition obtained by said production method can be shaped in the form of a film. The extrusion method can be used in shaping the polymeric film. The thickness of said polymeric film can be in the range of 10-70 μm. A Digimatic Micrometer can be used for measuring the film thickness.

According to the invention, said production method may comprise the steps of dispersing halloysite nanotubes loaded with the phase change material in the polymeric film and/or coating them on the surface of the polymeric film.

The invention also includes the use of a polymeric composition containing at least one polymer and halloysite nanotubes, wherein at least a portion of said halloysite nanotubes is loaded with a phase change material and each of the loaded halloysite nanotubes contains at most one kind of phase change material, as a packaging material. In the transportation and storage of the cold chain products, it is aimed to cut off the contact with air in order to prevent spoilage of the product. At this point, it is preferred that said products are packaged with packaging materials. Packaging materials must have a cooling effect in order to enable the transportation and storage of the products without breaking the cold chain. The inventors have found that the desired cooling effect is achieved with the polymeric composition of the present invention containing at least one polymer and halloysite nanotubes. The phase change material in the polymeric composition of the invention, which is used as a packaging material, cools the environment by absorbing the heat of the environment during the transformation from the solid state to the liquid state. Thus, the temperature of the products that need to be kept cold for a certain period of time can remain at the desired levels.

According to another embodiment of the invention, the packaging material containing said polymeric composition can be in the form of a film. The packaging material in the form of a film containing the polymeric composition of the invention is used for coating products that are intended to be kept cold. It is known to use phase change materials in cooling systems such as paper and foam. However, since said systems do not offer practical use in all cases, the packaging material containing said polymeric composition can be designed in the form of a film in order to cover the products that are desired to be kept cold.

The invention also includes the packaging material being a food packaging material. Said packaging material may also be a pharmaceutical packaging material.

Below is an exemplary embodiment of the polymeric composition described according to the present invention. The scope of protection of the present invention is defined by the claims and is not limited to the content of the example.

### EXAMPLE

According to an embodiment of the invention, the polymeric composition in the form of a film is synthesized as follows. At first, the phase change material is dissolved in methanol, which is then mixed with halloysite nanotubes. The resulting mixture is subjected to sonication. In order to remove the methanol in the medium, vacuuming is performed at 70° C. In this way, the phase change material is impregnated into the halloysite nanotubes, which is allowed to stand at 50° C. for 24 hours. The polymeric composition thus prepared is extruded and a flexible polymeric film is obtained.

1. A polymeric composition comprising at least one polymer and halloysite nanotubes, wherein at least a portion of the halloysite nanotubes is loaded with a phase change material, and each of the halloysite nanotubes loaded with the phase change material comprises at most one kind of phase change material.

2. The polymeric composition according to claim 1, wherein all of the halloysite nanotubes loaded with the phase change material comprise a single type of phase change material.

3. The polymeric composition according to claim 1, wherein the at least one polymer comprises polyethylene, polypropylene, polyethylene terephthalate, polyamide, polystyrene, polyvinylchloride, polycarbonate, or a combination thereof.

4. (canceled)

5. (canceled)

6. (canceled)

7. (canceled)

8. The polymeric composition according to claim 1, wherein the phase change material comprises triethylene glycol, polyethylene glycol 400, polyethylene glycol 600, or a combination thereof.

9. The polymeric composition according to claim 1, wherein the polymeric composition comprises hollow halloysite nanotubes in addition to the halloysite nanotubes loaded with the phase change material.

10. (canceled)

11. A method of producing a polymeric composition comprising at least one polymer and halloysite nanotubes, comprising steps of:
loading at least a portion of the halloysite nanotubes with a phase change material, wherein each of the halloysite nanotubes loaded with the phase change material comprises at most one type of phase change material, and
mixing the halloysite nanotubes loaded with the phase change material with the at least one polymer to obtain the polymeric composition.

12. The method according to claim 11, further comprising steps of:
dissolving the phase change material in a solvent to obtain a solution and subjecting the solution to a sonication together with the halloysite nanotubes, and
impregnating the phase change material into the halloysite nanotubes by removing the solvent in a medium by vacuuming.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. The polymeric composition according to claim 1, wherein the halloysite nanotubes loaded with the phase change material comprise at least two different phase change materials.

25. The polymeric composition according to claim 1, wherein the polymeric composition is in a form of a polymeric film.

26. The polymeric composition according to claim 25, wherein the polymeric film has a flexible structure.

27. The polymeric composition according to claim 25, wherein a film thickness of the polymeric film is between 10 μm-70 μm.

28. The polymeric composition according to claim 25, wherein the halloysite nanotubes loaded with the phase change material are dispersed in the polymeric film and/or coated on a surface of the polymeric film.

29. The method according to claim 11, wherein all of the halloysite nanotubes loaded with the phase change material comprise a single type of phase change material.

30. The method according to claim 11, wherein the halloysite nanotubes loaded with the phase change material comprise at least two different phase change materials.

31. The method according to claim 11, wherein the polymeric composition is shaped in a form of a polymeric film.

32. The method according to claim 31, wherein a film thickness of the polymeric film is between 10 μm-70 μm.

33. The method according to claim 31, further comprising a step of dispersing the halloysite nanotubes loaded with the phase change material in the polymeric film and/or coating the halloysite nanotubes loaded with the phase change material on a surface of the polymeric film.

34. A method of use of the polymeric composition produced by the method according to claim 31 as a packaging material.

35. The method of use according to claim 34, wherein the packaging material is a food packaging material.
